(19) United States
(12) Patent Application Publication
(10) Pub. No.: US 2009/0158615 A1
(43) Pub. Date: Jun. 25, 2009

(54) Method for Drying Wood Combined Into Stacks

(76) Inventor: Kurt Muehlboeck, Eberschwang (AT)

Correspondence Address: COLLARD & ROE, P.C., 1077 NORTHERN BOULEVARD, ROSLYN, NY, 11576, US

(21) Appl. No.: 12/226,243

(22) PCT Filed: Mar. 23, 2007
(86) PCT No.: PCT/AT2007/000141

§ 371 Date: Oct. 21, 2008

(30) Foreign Application Priority Data
Apr. 12, 2006 (AT) A 629/2006

(51) Int. Cl. F26B 3/02

(52) U.S. Cl. 34/487

(57) ABSTRACT

A method is described for drying wood combined into stacks (2) with the aid of a drying gas stream which flows through the wood stacks (2), which, by removing moist waste gas (8) after the wood stacks (2) and supplying fresh gas (9) before the wood stacks (2), is passed through the wood stacks (2) partially in circulation, wherein the wood is dried more rapidly with a moisture content above the fibre saturation than with a moisture content below the fibre saturation. In order to provide advantageous, economical drying conditions, it is proposed that before its slower drying with the aid of the drying gas stream guided partially in circulation, the wood is dried more rapidly with a drying gas stream consisting substantially only of fresh gas.

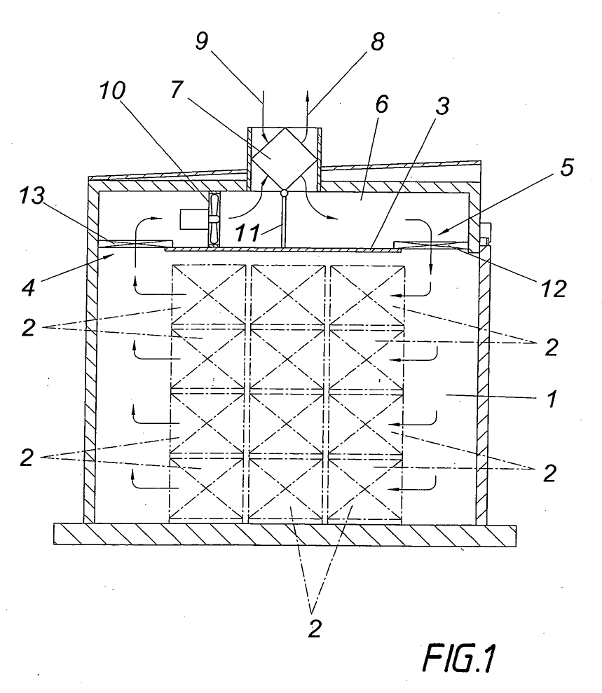

### 1. FIELD OF THE INVENTION

The present invention relates to a method for drying wood stored in stacks with the aid of a drying gas stream which flows through the wood stacks, which, by removing moist waste gas after the wood stacks and supplying fresh gas before the wood stacks, is passed through the wood stacks partially in circulation, wherein the wood is dried more rapidly when it has a moisture content above the fibre saturation than when it has a moisture content below the fibre saturation.

### 2. DESCRIPTION OF THE PRIOR ART

For drying wood stored in stacks, a drying gas stream is usually conveyed through the wood stacks, wherein moisture is released from the wood surface to the drying gas and specifically as a function of the gas temperature, the gas humidity and the flow rate of the drying gas. In this case, the drying gas, usually drying air, is passed through the wood stacks partially in circulation, wherein a partial stream is separated from the circulation for removing the moisture and is replaced by heated fresh gas. The moisture of the drying gas supplied to the wood stacks as a function of the residual moisture of the wood for the desired drying profile can be predetermined by means of the amount of moist waste gas removed and the supplied drier fresh gas. With regard to the shortest possible drying time, a comparatively high flow rate is selected for the drying gas steam which results in an appreciable energy input.

The fact that the drying rate of wood having a moisture content above the fibre saturation, i.e. wood having a free water fraction, substantially only depends on the amount of heat supplied and only depends on the moisture content when the moisture content is below the fibre saturation, i.e. when water is only bound in the wood cell walls, has had the result (AT 412 741 B) that wood stacks having a different average initial moisture above the fibre saturation are dried as far as fibre saturation at different speeds so that as a result of the associated different drying rates, despite the different initial moisture, all the wood stacks simultaneously reach fibre saturation and consequently can be dried together to the desired final moisture below fibre saturation and specifically taking into account a considerably slower drying process which is advantageous for this purpose. In order to ensure the different drying rates of the wood stacks with the different average initial moistures above the fibre saturation, the removed quantities of waste gas and the supplied quantities of fresh gas for the wood stacks are controlled independently on one another in zones. Thus, however, the energy expenditure for the circulatory flow of the drying gas remains correspondingly high.

### SUMMARY OF THE INVENTION

It is therefore the object of the invention to configure a method for drying wood of the type specified initially in such a manner that short drying times can be ensured with a comparatively low energy input without damaging the wood to be dried.

The invention achieves the formulated object whereby, before its slower drying with the aid of the partially circulating drying gas stream, the wood is dried more rapidly with a drying gas stream at least substantially consisting only of fresh gas.

The invention is based on the finding that above the fibre saturation, wood can be dried arbitrarily rapidly without suffering damage. This means that above the fibre saturation, no drying gas stream having a certain minimum moisture is required so that a partial circulating guidance of the drying gas stream can be dispensed with. If comparatively dry fresh gas is supplied to the wood having a moisture content above the fibre saturation, high drying rates with a low flow rate of the drying gas can be achieved with the advantage that the expenditure for maintaining a sufficient drying gas flow remains limited compared to conventional drying methods. In addition, the gas temperature can be kept low so that the risk of discolorations as a result of the temperature loadings, can be avoided even with deciduous woods which are particularly susceptible to such discolorations. The rapid drying of the wood with the aid of drying gas having low moisture content takes place during a drying phase in which the wood has a moisture content above the fibre saturation. At the latest in the region of the fibre saturation, however, the drying must be converted to a conventional guidance of the drying gas in partial circulation to avoid drying damage which only appears below the fibre saturation.

As has already been stated, by dispensing with a drying gas fraction guided through the wood stacks in circulation when the moisture content is above the fibre saturation, the treatment temperature for the wood can be kept low and specifically at completely economical drying rates. For particularly sensitive types of woods, it has surprisingly been found that at a wood temperature of at most 0° C. during an initial section of the drying with fresh gas, an advantageous treatment of the wood in the sense of the wood colouration is possible. The water frozen in the wood in this case vaporises at a correspondingly low moisture content of the drying gas without previously liquefying.

When drying less colour-sensitive woods, the drying rate in the region where the wood moisture is above the fibre saturation can also be increased by a moderate heating of the drying gas, whereby after preheating in heat exchange with the sensible waste heat of the removed waste gas, the fresh gas is heated by means of at least one heater battery before flowing through the wood stack, which results in an advantageous utilisation of the thermal energy.

### BRIEF DESCRIPTION OF THE DRAWING

The method for drying wood according to the invention is described in detail with reference to the drawing and specifically a device for carrying out the method is shown in schematic cross-section.

### DESCRIPTION OF THE PREFERRED EMBODIMENTS

The device shown for drying wood comprises in conventional manner a drying chamber 1 in which the wood to be dried in stored in stacks 2 depicted by dotdash lines. Above the storage area for the wood stacks 2 the drying chamber 1 is provided with an intermediate ceiling 3 which forms a flow channel 6 connecting the outlet 4 for the drying gas flowing through the storage area with the inlet 5. This flow channel 6 is connected to a cross-flow heat exchanger 7 via which waste gas 8 is removed from the storage area and fresh gas 9 is supplied. Fans 10 distributed over the length of the drying chamber 1 are provided for conveying the drying gas through the storage area. With the aid of at least one control valve 11 disposed in the flow channel 6, the ratio between the amounts of waste gas or fresh gas on the one hand and the fraction of the drying gas guided in circulation through the flow channel 6 on the other hand can be selected depending on the drying process. In the closed position of the control valve 11 which is shown, the flow channel 6 is shut off so that a circulating flow of drying gas through the drying chamber 1 is prevented and the fresh gas 9 extracted via the cross-flow heat exchanger 7 constitutes the entire drying gas stream which, after flowing through the wood stack 2, is removed as waste gas 8 again via the cross-flow heat exchanger 7. A heater battery 12 can be provided in the area of the inlet 5 for heating the supplied fresh gas 9. According to the exemplary embodiment, a heater battery 13 is also disposed in the area of the outlet 4 which is used when the drying gas stream is reversed in its direction of flow in some cases.

The drying of wood stacks 2 stored in the storage area of the drying chamber 1 takes place initially with the control valve 11 closed at least substantially only with the aid of the fresh gas 9 extracted via the fan 10, which has a comparatively low moisture content and therefore allows rapid drying of the wood as long as the wood moisture lies above fibre saturation. Fresh air is usually used as fresh gas. However, waste gases from heating boilers or other devices can advantageously also be used for the wood drying if these gases are sufficiently dry. Depending on the type of wood to be dried, the fresh gas 9 can be more or less additionally heated by means of the heater battery 12 in the inlet 5 in order to increase the drying rate without needing to accept any temperature damage to the wood. Since the sensible waste heat of the waste gas 8 which removes the moisture from the wood surface can be used in the cross-flow heat exchanger 7 for pre-heating the fresh gas 9, the amount of heat to be supplied via the heater battery 12 can be comparatively small, especially as the wood temperature should be limited with respect to the risk of discoloration, especially of colour-sensitive deciduous woods. Particularly favourable conditions are ensured in this connection if the wood temperature is kept below 0° C. Despite this, an economical drying rate can be ensured because, on account of the lack of a circulating flow of drying gas via the flow channel 6, the moisture content of the drying gas is exclusively determined by the moisture content of the fresh gas 9 which is kept correspondingly low. Above the fibre saturation, an extremely low gas moisture has no disadvantageous influence on the drying progress.

The low gas moisture caused by using substantially only fresh gas allows a considerably reduction of the flow rate of the drying gas through the wood stacks 2 which significantly reduces the energy input for conveying the drying gas. However, the lack of circulating component of the drying gas flow requires sufficiently large amounts of fresh gas or waste gas. In order to ensure a corresponding volume flow, the drying chamber 1 is not provided in the conventional manner with individual gas inlet and outlet openings distributed over the chamber length but with continuous openings over the chamber length for the supply of fresh gas 9 or the removal of waste gas 8.

As soon as the wood stacks 2 are dried to a moisture content in the range of the fibre saturation, for gentle drying of the wood to a final moisture below the fibre saturation, a fraction of the drying gas is to be guided in a proven manner in circulation via the flow channel 6 so that a higher gas moisture is established for the drying gas flow stream through the wood stacks 2. For this purpose, the control valve 11 is to be opened, whereby the fraction of the circulatory flow can be controlled by the valve position. In the completely open valve position, the waste gas or the fresh gas can be shut off, which results in exclusive circulatory guidance of the drying gas. The higher heat requirement possibly required during an at least partial circulatory guidance of the drying gas can be met by the heater battery 13 in the outlet 4.

1. A method for drying wood combined in stacks with the aid of a drying gas stream which flows through the wood stacks, which, by removing moist waste gas after the wood stacks and supplying fresh gas before the wood stacks, is passed through the wood stacks partially in circulation, wherein the wood is dried more rapidly with a moisture content above the fibre saturation than with a moisture content below the fibre saturation, wherein before its slower drying with the aid of the drying gas stream guided partially in circulation, the wood is dried more rapidly with a drying gas stream consisting substantially only of fresh gas.

2. The method according to claim 1, wherein the wood has a temperature of at most 0° C. at least during the initial section of the drying with fresh gas.

3. The method according to claim 1, wherein the fresh gas is heated by at least one heater battery after pre-heating in heat exchange with the sensible waste heat of the removed waste gas before flowing through the wood stacks.
